(19) United States
(12) Patent Application Publication
(10) Pub. No.: US 2012/0129699 A1
(43) Pub. Date: May 24, 2012

(54) Liquid Composition Containing a Pesticide, a Non-ionic Surfactant and a Propionamide

(75) Inventors: Christian Sowa, Neustadt (DE); Wolfgang Ladner, Fussgoenheim (DE); Andreas Lanver, Mannheim (DE)

(73) Assignee: BASF SE, Ludwigshafen (DE)

(21) Appl. No.: 13/386,729

(22) PCT Filed: Jul. 26, 2010
(86) PCT No.: PCT/EP10/60766

§ 371 Date: Jan. 24, 2012

(30) Foreign Application Priority Data
Jul. 31, 2009 (EP) 09166964.8

(51) Int. Cl. A01N 25/00; A01N 25/02; A01P 21/00; A01P 7/04; A01P 7/02; A01P 13/00; A01N 25/30; A01P 3/00

(52) U.S. Cl. 504/363; 504/358; 514/788

(57) ABSTRACT

The present invention relates to a liquid composition comprising a pesticide in dissolved form, a nonionic surfactant, and a propionamide of the formula I mentioned hereinbelow. The invention furthermore relates to a process for the preparation of the composition according to the invention by bringing the pesticide, the nonionic surfactant and the propionamide into contact with one another. It also relates to a use of the composition according to the invention for preparing an emulsion, and to an emulsion comprising water and the composition according to the invention.

The present invention relates to a liquid composition comprising a pesticide in dissolved form, a nonionic surfactant, and a propionamide of the formula I mentioned hereinbelow. The invention furthermore relates to a process for the preparation of the composition according to the invention by bringing the pesticide, the nonionic surfactant and the propionamide into contact with one another. It also relates to a use of the composition according to the invention for preparing an emulsion, and to an emulsion comprising water and the composition according to the invention. The present invention comprises combinations of preferred features with other preferred features.

In general, pesticides are not employed as pure substances but, depending on the field of application and the desired physical constituency of the use form, as a combination with certain adjuvants, i.e. they are “formulated”. Independently of the type of formulation and of whether the formulations comprise one or more active substances, one attempts, in particular in the field of agriculture, to achieve as high an active substance concentration as possible of the respective formulation since a high concentration of the active substances allows the volumes to be applied to be reduced and, as a consequence, entails savings with regard to the adjuvant materials applied and with regard to packaging and logistics. Highly-concentrated stable formulations and coformulations with environmentally friendly adjuvants are therefore of interest as a matter of principle.

beta-Alkoxypropionamides and their preparation processes are generally known: JP 2005-47885 discloses beta-alkoxypropionamides, their production and their use in agriculture. WO 2007/148574 discloses beta-alkoxypropionamides for removing photosensitive resists on electronics components. U.S. Pat. No. 2,704,280 discloses a detergent composed of a water-soluble, organic sulfate or sulfonate and an organic builder from the group of the alkoxyalkanoic acid amides. WO 2006/075373 discloses beta-alkoxypropionamides, their production and their use.

It was an object of the present invention to find a composition in which high concentrations of pesticides, in particular pesticides which are sparingly soluble in water, can be dissolved to give a clear solution. Moreover, it was intended that the composition form a stable emulsion upon the addition of water. Moreover, it was intended that the composition be composed of constituents which can be employed for the agrochemical treatment of plants.

The object was achieved by a liquid concentrate comprising a pesticide in dissolved form, a nonionic surfactant, and a propionamide of the formula I

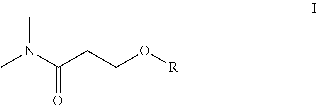

where R is a linear or branched C₃- to C₁₂-alkyl radical. R is preferably a linear or branched C₃- to C₁₀-alkyl radical, especially preferably a C₄- to C₈-alkyl radical, and in particular a C₆- to C₈-alkyl radical. The alkyl radical is preferably free from heteroatoms. Examples of the alkyl radical are linear or branched propyl, butyl, pentyl, hexyl, heptyl or octyl, nonyl, decyl, or dodecyl radicals. Specifically preferably, R is iso-butyl, n-hexyl, 2-ethylhexyl, 2-propylheptyl, 3,5,5-trimethylhexyl, 7-methyloctyl, 8-methylnonyl or n-decyl. In particular, R is iso-butyl, n-hexyl, 2-ethylhexyl, 2-propylheptyl, 3,5,5-trimethylhexyl, 7-methyloctyl, 8-methylnonyl or n-decyl; in particular iso-butyl, n-hexyl, 2-ethylhexyl; and very specifically 2-ethylhexyl.

The propionamides of the formula I and their preparation are generally known, for example from the abovementioned specifications JP 2005-47885, U.S. Pat. No. 2,704,280 and WO 2007/148574. In most cases, the propionamides are obtained by subjecting N,N-dimethylacrylamide to an addition reaction with the corresponding alcohol. The alcohol may also take the form of a mixture of alcohols. The reaction product can be purified by distillation. Usually, the propionamides employed have a purity of at least 90% by weight, preferably at least 95% by weight and in particular at least 99% by weight.

The concentrate may comprise from 5 to 90% by weight, preferably from 15 to 80% by weight and in particular from 25 to 70% by weight of propionamide.

The concentrate is a liquid composition comprising a pesticide in dissolved form, a nonionic surfactant, and a propionamide of the formula I. Liquid means that the viscosity of the concentrate at 20° C. amounts to no more than 5000 mPas, preferably no more than 500 mPas and in particular no more than 200 mPas. The concentrate is preferably a clear solution.

The pesticide is present in the concentrate in dissolved form. This means that at least 90% by weight, preferably at least 99% by weight and in particular at least 99.9% by weight of the pesticide present in the concentrate are present in dissolved form. Usually, no pesticide particles can be discerned in the concentrate with the naked eye.

The concentrate may comprise from 0.5 to 60% by weight, preferably from 2 to 50% by weight and in particular from 5 to 40% by weight of pesticide.

The term pesticide refers to at least one active substance selected from the group of the fungicides, insecticides, nematicides, herbicides, safeners and/or growth regulators. Preferred pesticides are fungicides, insecticides, and herbicides, in particular fungicides. Mixtures of pesticides from two or more of the above-mentioned classes may also be used. A person skilled in the art is familiar with such pesticides, which can be found, for example, in Pesticide Manual, 14th Ed. (2006), The British Crop Protection Council, London.

Suitable examples of fungicides are:

### A) Strobilurins:

azoxystrobin, dimoxystrobin, enestroburin, fluoxastrobin, kresoxim-methyl, metominostrobin, orysastrobin, picoxystrobin, pyraclostrobin, pyribencarb, trifloxystrobin, N-methyl-2-(2-(6-(3-chloro-2-methylphenoxy)-5-fluoropyrimidin-4-yloxy)phenyl)-2-methoxyiminoacetamide, 2-(ortho-((2,5-dimethylphenyloxymethylene)phenyl)-3-methoxyacrylic acid methyl ester, 3-methoxy-2-(2-(N-(4-methoxyphenyl)cyclopropanecarboximidoylsulfanylmethyl)phenyl)acrylic acid methyl ester, N-methyl-2-(2-(3-(2,6-dichlorophenyl)-1-methylallylideneaminooxymethyl)phenyl)-2-methoxyiminoacetamide;

### B) Carboxamides:

carboxanilides: benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, metalaxyl-M (mefenoxam), ofurace, oxadixyl, oxycarboxin, penflufen (N-(2-(1,3-dimethylbutyl)phenyl)-1,3-dimethyl-5-fluoro-1H-pyrazole-4-carboxamide), penthiopyrad, sedaxane, tecioftalam, thifluzamide, tiadinil, 2-amino-4-methylthiazole-5-carboxanilide, 2-chloro-N-(1,1,3-trimethylindan-4-yl)nicotinamide, N-(3′,4′,5′-trifluorobiphenyl-2-yl)-3-difluoromethyl-1-methyl-1H-pyrazole-4-carboxamide, N-(4′-trifluoromethylthiobiphenyl-2-yl)-3-difluoromethyl-1-methyl-1H-pyrazole-4-carboxamide, N-(2-(1,3,3-trimethylbutyl)phenyl)-1,3-dimethyl-5-fluoro-1H-pyrazole-4-carboxamide,
carboxylic acid morpholides: dimethomorph, flumorph, pyrimorph;
benzamides: flumetover, fluopicolide, fluopyram, zoxamide, N-(3-ethyl-3,5,5-trimethylcyclohexyl)-3-formylamino-2-hydroxybenzamide;
other carboxamides: carpropamid, diclocymet, mandipropamid, oxytetracyclin, silthiofam, N-(6-methoxypyridin-3-yl)cyclopropanecarboxamide;

### C) Azoles

triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazol, penconazole, propiconazole, prothioconazole, simeconazole, tebuconazole, tetraconazole, triadimefon, triadimenol, triticonazole, uniconazole, 1-(4-chlorophenyl)-2-([1,2,4]triazol-1-yl)cycloheptanol;
imidazoles: cyazofamid, imazalil, imazalil sulfate, pefurazoate, prochloraz, triflumizole;
benzimidazoles: benomyl, carbendazim, fuberidazole, thiabendazole;
others: ethaboxam, etridiazole, hymexazole, 2-(4-chlorophenyl)-N-[4-(3,4-dimethoxyphenyl)isoxazol-5-yl]-2-prop-2-ynyloxyacetamide;

D) Nitrogen-comprising heterocyclyl compounds
pyridines: fluazinam, pyrifenox, 3-[5-(4-chlorophenyl)-2,3-dimethylisoxazolidin-3-yl]pyridine, 3-[5-(4-methylphenyl)-2,3-dimethylisoxazolidin-3-yl]pyridine, 2,3,5,6-tetrachloro-4-methanesulfonylpyridine, 3,4,5-trichloropyridine-2,6-dicarbonitrile, N-(1-(5-bromo-3-chloropyridin-2-yl)ethyl)-2,4-dichloronicotinamide, N-((5-bromo-3-chloropyridin-2-yl)methyl)-2,4-dichloronicotinamide;
pyrimidines: bupirimate, cyprodinil, diflumetorim, fenarimol, ferimzone, mepanipyrim, nitrapyrin, nuarimol, pyrimethanil;
piperazines: triforine;
pyrroles: fludioxonil, fenpiclonil;
morpholines: aldimorph, dodemorph, dodemorph acetate, fenpropimorph, tridemorph;
piperidines: fenpropidin;
dicarboximides: fluorimide, iprodione, procymidone, vinclozolin;
nonaromatic 5-heterocyclic rings: famoxadone, fenamidone, flutianil, octhilinone, probenazole, 5-amino-2-isopropyl-3-oxo-4-ortho-tolyl-2,3-dihydropyrazole-1-thiocarboxylic acid S-allyl ester;
others: acibenzolar-S-methyl, amisulbrom, anilazin, blasticidin-S, captafol, captan, quinomethionate, dazomet, debacarb, diclomezine, difenzoquat, difenzo-quat-methylsulfate, fenoxanil, folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxypyrimidin-2-yl)-2-methyl-1H-benzoimidazole, 5-chloro-7-(4-methylpiperidin-1-yl)-6-(2,4,6-trifluorophenyl)-[1,2,4]triazolo[1,5-a]pyrimidine, 5-ethyl-6-octyl-[1,2,4]triazolo[1,5-a]pyrimidin-7-ylamine,
   E) Carbamates and dithiocarbamates
thio- and dithiocarbamates: ferbam, mancozeb, maneb, metam, methasulfocarb, metiram, propineb, thiram, zineb, ziram;
carbamates: diethofencarb, benthiavalicarb, iprovalicarb, propamocarb, propamocarb hydrochloride, valiphenal, 4-fluorophenyl N-(1-(1-(4-cyanophenyl)ethanesulfonyl)but-2-yl)carbamate;
   F) Other fungicides
guanidines: dodine, dodine (free base), guazatine, guazatine acetate, iminoctadine, iminoctadine triacetate, iminoctadine tris(albesilate);
antibiotics: kasugamycin, kasugamycin hydrochloride hydrate, polyoxins, streptomycin, validamycin A;
nitrophenyl derivatives: binapacryl, dicloran, dinobuton, dinocap, nitrothal-isopropyl, tecnazene;
organometallic compounds: fentin salts, such as, for example, fentin acetate, fentin chloride, fentin hydroxide;
sulfur-comprising heterocyclyl compounds: dithianon, isoprothiolane;
organophosphorus compounds: edifenphos, fosetyl, fosetyl-aluminum, iprobenfos, phosphorous acid and its salts, pyrazophos, tolclofos-methyl;
organochlorine compounds: chlorothalonil, dichlofluanid, dichlorphen, flusulfamide, hexachlorobenzene, pencycuron, pentachlorophenol and its salts, phthalide, quintozene, thiophanate-methyl, tolylfluanid, N-(4-chloro-2-nitrophenyl)-N-ethyl-4-methylbenzenesulfonamide;
inorganic active ingredients: phosphorous acid and its salts, Bordeaux mixture, copper salts, such as, for example, copper acetate, copper hydroxide, copper oxychloride, basic copper sulfate, sulfur;
others: biphenyl, bronopol, cyflufenamid, cymoxanil, diphenylamine, metrafenone, mildiomycin, oxine-copper, prohexadione-calcium, spiroxamine, tolylfluanid, N-(cyclopropylmethoxyimino-(6-difluoromethoxy-2,3-difluorophenyl)-methyl)-2-phenylacetamide, N′-(4-(4-chloro-3-trifluoromethylphenoxy)-2,5-dimethylphenyl)-N-ethyl-N-methylformamidine, N′-(4-(4-fluoro-3-trifluoro-methylphenoxy)-2,5-dimethylphenyl)-N-ethyl-N-methylformamidine, N′-(2-methyl-5-trifluoromethyl-4-(3-trimethylsilanylpropoxy)phenyl)-N-ethyl-N-methyl-formamidine, N′-(5-difluoromethyl-2-methyl-4-(3-trinnethylsilanylpropoxy)phenyl)-N-ethyl-N-methylformamidine, N-methyl-(1,2,3,4-tetrahydronaphthalen-1-yl)-2-{1-[2-(5-methyl-3-trifluoromethylpyrazol-1-yl)acetyl]piperidin-4-yl}thiazole-4-carboxyamide, N-methyl-(R)-1,2,3,4-tetrahydronaphthalen-1-yl-2-{1-[2-(5-methyl-3-trifluoromethylpyrazol-1-yl)acetyl]piperidin-4-yl}thiazole-4-carboxamide, 6-tert-butyl-8-fluoro-2,3-dimethylquinolin-4-ylacetate, 6-tert-butyl-8-fluoro-2,3-dimethylquinolin-4-ylmethoxyacetate, N-methyl-2-{1-[2-(5-methyl-3-trifluoro-methyl-1H-pyrazol-1-yl)acetyl]piperidin-4-yl}-N-[(1(R)-1,2,3,4-tetrahydro-naphthalen-1-yl]-4-thiazolecarboxamide.

Suitable examples of growth regulators are:

abscisic acid, amidochlor, ancymidole, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidole, fluthiacet, forchlorfenuron, gibberellic acid, inabenfid, indole-3-acetic acid, maleic hydrazide, mefluidid, mepiquat (mepiquat chloride), metconazole, naphthaleneacetic acid, N-6-benzyladenine, paclobutrazole, prohexadione (prohexadione-calcium), prohydrojasmone, thidiazuron, triapenthenol, tributyl phosphorotrithioate, 2,3,5-tri-iodobenzoic acid, trinexapac-ethyl and uniconazole.

Suitable examples of herbicides are:
acetamides: acetochlor, alachlor, butachlor, dimethachlor, dimethenamid, flufenacet, mefenacet, metolachlor, metazachlor, napropamide, naproanilide, pethoxamid, pretilachlor, propachlor, thenyichlor;
amino acid analogs: bilanafos, glyphosate, glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
bipyridyls: diquat, paraquat;
carbamates and thiocarbamates: asulam, butylate, carbetamide, desmedipham, dimepiperate, eptam (EPTC), esprocarb, molinate, orbencarb, phenmedipham, prosulfocarb, pyributicarb, thiobencarb, tri-allate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen;
hydroxybenzonitriles: bromoxynil, dichiobenil, ioxynil;
imidazolinones: imazamethabenz, imazamox, imazapic, imazapyr, imazaquin, imazethapyr;
phenoxyacetic acids: clomeprop, 2,4-dichlorophenoxyacetic acid (2,4-D), 2,4-DB, dichlorprop, MCPA, MCPA-thioethyl, MCPB, mecoprop;
pyrazines: chloridazon, flufenpyr-ethyl, fluthiacet, norflurazon, pyridate;
pyridines: aminopyralid, clopyralid, diflufenican, dithiopyr, fluridone, fluoroxypyr, picloram, picolinafen, thiazopyr;
sulfonyl ureas: amidosulfuron, azimsulfuron, bensulfuron, chiorimuron-ethyl, chiorsulfuron, cinosulfuron, cyclosulfamuron, ethoxysulfuron, flazasulfuron, fluce-tosulfuron, flupyrsulfuron, foramsulfuron, halosulfuron, imazosulfuron, iodosulfuron, mesosulfuron, metsulfuron-methyl, nicosuifuron, oxasulfuron, primisulfuron, prosulfuron, pyrazosulfuron, rimsulfuron, sulfometuron, sulfosuifuron, thifensulfuron, triasuifuron, tribenuron, trifloxysulfuron, triflusulfuron, tritosuifuron, 1-((2-chloro-6-propyl-imidazo[1,2-b]pyridazin-3-yl)sulfonyl)-3-(4,6-dimethoxypyrimidin-2-yl)urea;
triazines: ametryne, atrazine, cyanazine, dimethametryne, ethiozine, hexazinone, metamitron, metribuzine, prometryne, simazine, terbuthylazine, terbutryne, triaziflam;
ureas: chlorotoluron, daimuron, diuron, fluometuron, isoproturon, linuron, methabenzthiazuron, tebuthiuron;
other acetolactate synthase inhibitors: bispyribac-sodium, cloransulam-methyl, diclosulam, florasulam, flucarbazone, flumetsulam, metosulam, ortho-sulfamuron, penoxsulam, propoxycarbazone, pyribambenz-propyl, pyribenzoxim, pyriftalid, pyriminobac-methyl, pyrimisulfan, pyrithiobac, pyroxasulfon, pyroxsulam;
others: amicarbazone, aminotriazole, anilofos, beflubutamid, benazolin, bencarbazone, benfluresate, benzofenap, bentazone, benzobicyclon, bromacil, bromobutide, butafenacil, butamifos, cafenstrole, carfentrazone, cinidon-ethlyl, chlorthal, cinmethylin, clomazone, cumyluron, cyprosulfamide, dicamba, difenzoquat, diflufenzopyr, Drechslera monoceras, endothal, ethofumesate, etobenzanide, fentrazamide, flumiciorac-pentyl, flumioxazin, flupoxam, fluorochloridone, flurtamon, indanofan, isoxaben, isoxaflutole, lenacil, propanil, propyzamide, quinclorac, quinmerac, mesotrione, methylarsenic acid, naptalam, oxadiargyl, oxadiazone, oxaziclomefon, pentoxazon, pinoxaden, pyraclonil, pyraflufen-ethyl, pyrasulfotole, pyrazoxyfen, pyrazolynate, quinoclamine, saflufenacil, sulcotrione, sulfentrazone, terbacil, tefuryltrione, tembotrione, thiencarbazone, topramezone, 4-hydroxy-3-[2-(2-methoxyethoxymethyl)-6-trifluoromethylpyridine-3-carbonyl]-bicyclo[3.2.1]oct-3-en-2-one, ethyl (3-[2-chloro-4-fluoro-5-(3-methyl-2,6-dioxo-4-trifluoromethyl-3,6-dihydro-2H-pyrimidin-1-yl)-phenoxy]-pyridin-2-yloxy)acetate, methyl 6-amino-5-chloro-2-cyclopropylpyrimidine-4-carboxylate, 6-chloro-3-(2-cyclopropyl-6-methylphenoxy)-pyridazin-4-ol, 4-amino-3-chloro-6-(4-chlorophenyl)-5-fluoropyridine-2-carboxylic acid, methyl 4-amino-3-chloro-6-(4-chloro-2-fluoro-3-methoxyphenyl)pyridine-2-carboxylate and methyl 4-amino-3-chloro-6-(4-chloro-3-dimethylamino-2-fluorophenyl)pyridine-2-carboxylate.

Suitable examples of insecticides are:
organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin,
insect growth inhibitors: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramate;
nicotin receptor agonists/antagonists: clothianidin, dinotefuran, imidacloprid, thiamethoxam, nitenpyram, acetamiprid, thiacloprid, 1-(2-chlorothiazol-5-ylmethyl)-2-nitrimino-3,5-dimethyl-[1,3,5]triazinane;
GABA antagonists: endosulfan, ethiprole, fipronil, vaniliprole, pyrafluprole, pyriprole, 5-amino-1-(2,6-dichloro-4-methylphenyl)-4-sulfinamoyl-1H-pyrazole-3-thiocarboxamide;
macrocyclic lactones: abamectin, emamectin, milbemectin, lepimectin, spinosad, spinetoram;
mitochondrial electron transport chain inhibitor (METI) I acaricides: fenazaquin, pyridaben, tebufenpyrad, tolfenpyrad, flufenerim;
METI II and III substances: acequinocyl, fluacyprim, hydramethylnon;
decouplers: chlorfenapyr;
inhibitors of oxidative phosphorylation: cyhexatin, diafenthiuron, fenbutatin oxide, propargite;
insect ecdysis inhibitors: cryomazine;
inhibitors of ‘mixed function oxidases’: piperonyl butoxide;
sodium channel blockers: indoxacarb, metaflumizone;
others: benclothiaz, bifenazate, cartap, flonicamid, pyridalyl, pymetrozine, sulfur, thiocyclam, flubendiamide, chloranthraniliprole, cyazypyr (HGW86); cyenopyrafen, flupyrazofos, cyflumetofen, amidoflumet, imicyafos, bistrifluoron and pyrifluquinazone.

Preferred pesticides are metconazole, epoxiconazole and boscalid.

Furthermore preferred are pesticides which are soluble in water to no more than 20 g/l, preferably to no more than 1 g/l and in particular to no more than 0.2 g/l at 20° C. Examples of such pesticides which are sparingly soluble in water are (water solubility at 20° C. in each case within parentheses): epoxiconazole (6.6 mg/l), boscalid (4.6 mg/l), metrafenone (0.5 mg/l), metconazole (30.4 mg/l).

The concentrate comprises a nonionic surfactant, that is to say comprises at least one nonionic surfactant, for example one or two different nonionic surfactants. The concentrate may comprise from 0.5 to 40% by weight, preferably from 1 to 30% by weight and in particular from 2 to 20% by weight of nonionic surfactant.

Suitable nonionic surfactants are alkoxylates, N-alkylated fatty acid amides, aminoxides, esters, block polymers or sugar-based surfactants. Examples of alkoxylates are compounds such as alcohols, alkylphenols, amines, amides, arylphenols, fatty acids or fatty acid esters which have been alkoxylated. Ethylene oxide and/or propylene oxide, preferably ethylene oxide, may be applied for the alkoxylation reaction. Examples of N-alkylated fatty acid amides are fatty acid glucamides or fatty acid alkanolamides. Examples of esters are fatty acid esters, glycerol esters, or monoglycerides. Examples of sugar-based surfactants are sorbitans, ethoxylated sorbitans, sucrose and glucose esters or alkylpolyglucosides. Suitable block polymers are block polymers of the A-B or of the A-B-A type comprising blocks of polyethylene oxide and polypropylene oxide or of the A-B-C type comprising alkanol, polyethylene oxide and polypropylene oxide. Preferred nonionic surfactants are alkoxylates such as alcohols, alkylphenols, amines, amides, arylphenols, fatty acids or fatty acid esters which have been ethoxylated.

In addition to the nonionic surfactant, the concentrate may comprise an anionic surfactant. This means that the concentrate may comprise at least one anionic surfactant, for example one or two anionic surfactants. The concentrate may comprise from 0.5 to 40% by weight, preferably from 1 to 30% by weight and in particular from 2 to 20% by weight of anionic surfactant.

Suitable anionic surfactants are alkali metal, alkaline-earth metal or ammonium salts of sulfonates, sulfates, phosphates or carboxylates. Examples of sulfonates are alkylarylsulfonates, diphenylsulfonates, alpha-olefinsulfonates, sulfonates of fatty acids and oils, sulfonates of ethoxylated alkylphenols, condensed naphthalenesulfonates, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates and carboxylated alcohol or alkylphenol ethoxylates. Preferred anionic surfactants are alkali metal, alkaline-earth metal or ammonium salts of sulfonates, such as alkylarylsulfonates, diphenylsulfonates, alpha-olefinsulfonates, sulfonates of fatty acids and oils, sulfonates of ethoxylated alkylphenols, condensed naphthalenesulfonates, sulfonates of dodecyl- and tridecylbenzenes, sulfonate of naphthalenes and alkylnaphthalenes, sulfosuccinates or sulfosuccinamates. Especially preferred anionic surfactants are alkali metal, alkaline-earth metal or ammonium salts of alkylarylsulfonates.

The concentrate may comprise further formulation auxiliaries, the choice of auxiliary usually depending on the specific use. Examples of suitable formulation auxiliaries are solvents, surface-active substances (such as surfactants, protective colloids, wetters and adhesives), organic and inorganic thickeners, bactericides, antifrost agents, antifoams, if appropriate colorants and stickers (for example for the treatment of seed).

Suitable solvents (in addition to the propionamides of the formula I employed as solvents) are water, organic solvents such as mineral oil fractions of medium to high boiling point such as kerosene and diesel oil, furthermore coal tar oils and oils of vegetable or animal origin, aliphatic, cyclic and aromatic hydrocarbons, for example paraffins, tetrahydronaphthalene, alkylated naphthalenes and their derivatives, alkylated benzenes and their derivatives, alcohols such as methanol, ethanol, propanol, butanol and cyclohexanol, glycols, ketones such as cyclohexanone, gamma-butyrolactone, dimethyl fatty acid amides, fatty acids and fatty acid esters and strongly polar solvents, for example amines such as N-methylpyrrolidone. In principle, it is also possible to use solvent mixtures and also mixtures of the abovementioned solvents and water. The solvent is preferably an organic solvent. In most cases, the concentrate will comprise no more than 50% by weight, preferably no more than 20% by weight and in particular no more than 5% by weight of solvent. In one embodiment, the concentrate comprises no more than 10% by weight, preferably no more than 1% by weight and in particular no more than 0.1% by weight of water.

Surface-active substances which are suitable are the alkali metal, alkaline-earth metal, ammonium salts of aromatic sulfonic acids, for example of lignosulfonic acid (Borresperse® types, Borregaard, Norway), phenolsulfonic acid, naphthalenesulfonic acid (Morwet® types, Akzo Nobel, USA) and dibutylnaphthalenesulfonic acid (Nekal® types, BASF, Germany), and of fatty acids, alkyl- and alkylarylsulfonates, alkyl ether, lauryl ether and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, polyoxyethylene or polyoxypropylene alkyl ethers, lauryl alcohol polyglycol ether acetate, sorbitol esters, lignin-sulfite liquors, lignosulfonates, proteins, denatured proteins, polysaccharides (for example methylcellulose), hydrophobe-modified starches, polyvinyl alcohol (Mowiol® types, Clariant, Switzerland), polycarboxylates (Sokalan® types, BASF, Germany), polyalkoxylates, polyvinylamine (Lupamin® types, BASF, Germany), polyethyleneimine (Lupasol® types, BASF, Germany), polyvinylpyrrolidone and their copolymers. Suitable surfactants are, in particular, anionic, cationic, nonionic and amphoteric surfactants, block polymers and polyelectrolytes. Suitable cationic surfactants are quaternary surfactants, for example quaternary ammonium compounds with one or two hydrophobic groups, or salts of long-chain primary amines. Suitable amphoteric surfactants are alkylbetaines and imidazolines. Suitable polyelectrolytes are polyacids or polybases. Examples of polyacids are alkali metal salts of polyacrylic acid. Examples of polybases are polyvinylamines or polyethyleneamines.

Examples of adjuvants are organic-modified polysiloxanes, such as BreakThruS 240®; alcohol alkoxylates, such as Atplus®245, Atplus®MBA 1303, Plurafac®LF and Lutensol® ON; EO-PO block polymers, for example Pluronic® RPE 2035 and Genapol® B; alcohol ethoxylates, for example Lutensol® XP 80; and sodium dioctyl sulfosuccinate, for example Leophen® RA.

Examples of thickeners (i.e. compounds which impart a modified flow behavior to the composition, i.e. high viscosity at rest and low viscosity in the agitated state) are polysaccharides and organic and inorganic layered minerals such as xanthan gum (Kelzan®, CP Kelco), Rhodopol® 23 (Rhodia) or Veegum® (R.T. Vanderbilt) or Attaclay (Engelhard Corp.).

Bactericides may be added to stabilize the composition. Examples of bactericides are those based on dichlorophene and benzyl alcohol hemiformal (Proxel® from ICI or Acticide® RS from Thor Chemie and Kathon® MK from Rohm & Haas) and isothiazolinone derivatives such as alkylisothiazolinones and benzoisothiazolinones (Acticide® MBS from Thor Chemie). Examples of suitable antifreeze agents are ethylene glycol, propylene glycol, urea and glycerol. Examples of antifoams are silicone emulsions (such as, for example, Silikon® SRE, Wacker, Germany or Rhodorsil®, Rhodia, France), long-chain alcohols, fatty acids, salts of fatty acids, organofluorine compounds and their mixtures. Examples of stickers are polyvinylpyrrolidone, polyvinyl acetate, polyvinyl alcohol and cellulose ethers (Tylose®, Shin-Etsu, Japan).

The present invention furthermore relates to a process for the preparation of the concentrate according to the invention by bringing the pesticide, the nonionic surfactant and the propionamide of the formula I into contact with each other. The process gives a liquid composition in which the pesticide is present in dissolved form. Further components, preferably an anionic surfactant, may be added to the process in addition to the pesticide, nonionic surfactant and propionamide. Further formulation auxiliaries may also be added. The process can proceed at from 10 to 200° C., preferably at from 20 to 50° C. The individual components can be brought into contact with each other in any order, for example with stirring, shaking or mixing. Preferably, the propionamide is first introduced into the reaction vessel and mixed with the nonionic surfactant. The pesticide is subsequently dissolved in this mixture. The concentrate thus produced can optionally be filtered through a sieve (mesh size for example 100-200 μm).

The present invention furthermore relates to an emulsion comprising water and the concentrate according to the invention. Usually, the emulsion comprises an aqueous phase as the continuous phase and an oily phase as the dispersed phase. Solid particles (for example of a further pesticide) may additionally be present as the dispersed phase (so-called suspoemulsion). The dispersed phase usually forms droplets within the aqueous phase. The mean droplet size will, in most cases, be in the range of from at least 0.1 μm, preferably at least 0.3 μm, in particular at least 0.5 μm. It is preferably in the range of from 0.1 to 1000 μm, in particular from 0.2 to 5 μm and specifically from 0.4 to 2 μm. The mean droplet size can be determined by particle size measurement using laser diffraction, for example with a Malvern Mastersizer 2000.

The emulsion preferably comprises water, a pesticide in dissolved form, a nonionic surfactant, and a propionamide of the formula I. The continuous phase of the emulsion usually comprises water. The dispersed phase of the emulsion usually comprises the propionamide of the formula I. Preferably, the oily phase comprises the propionamide and the pesticide in dissolved form. This means that the pesticide is dissolved in the propionamide. In an especially preferred embodiment, the emulsion comprises water and the concentrate according to the invention, wherein the continuous phase comprises water and the dispersed phase the propionamide of the formula I and the pesticide, which is dissolved in the propionamide.

The weight ratio of water to concentrate may be from 10 000:1 to 1:10, preferably from 3000:1 to 1:1 and especially preferably from 1000:1 to 10:1 in the emulsion.

The emulsion can be employed directly as an aqueous spray mixture (so-called tank mix). The tank mix is usually applied by spraying or fogging. Oils of various types, wetters, adjuvants, herbicides, bactericides, fungicides may be added to the tank mix immediately prior to application (tank mix). These agents can be admixed to the compositions according to the invention in the weight ratio 1:100 to 100:1, preferably 1:10 to 10:1. The pesticide concentration in the tank mix may be varied within substantial limits. In general, it is between 0.0001 and 10%, preferably between 0.01 and 1%. When used in plant protection, the application rates are between 0.01 and 2.0 kg of active substances per ha, depending on the nature of the desired effect.

The emulsion can be prepared by bringing water and the concentrate according to the invention into contact with each other, for example by stirring, shaking or another form of mixing. The preparation can be effected for example directly in the spray tank.

The present invention furthermore relates to a use of the concentrate according to the invention for the preparation of an emulsion. The emulsion is preferably an aqueous emulsion, specifically an oil-in-water emulsion.

The present invention furthermore relates to the use of the concentrate according to the invention or of the emulsion according to the invention for controlling phytopathogenic fungi and/or undesired plant growth and/or undesired insect or mite attack and/or for regulating the growth of plants, by allowing the composition to act on the respective pests, their environment or the plants to be protected from the respective pests, the soil and/or on undesired plants and/or the useful plants and/or their environment. The invention furthermore relates to the use of the concentrate according to the invention or of the emulsion according to the invention for controlling undesired insect or mite attack on plants and/or for controlling phytopathogenic fungi and/or for controlling undesired plant growth, where seeds of useful plants are treated with the composition.

Advantages of the present invention are that a high concentration of pesticides, in particular pesticides which are sparingly soluble in water, can be dissolved in the concentrate to give a clear solution. The concentrate is storage-stable and the dissolved pesticide virtually does not crystallize out. Upon mixing with water, the concentrate readily forms an emulsion. Owing to this fact, the agricultural practitioner, for example, can prepare a sprayable tank mix by simply stirring a mixture of water and concentrate. The emulsion of the tank mixture is stable (for example, the active substance does not crystallize out over at least 24 h) and sprayable. It shows outstanding wetting of the leaf surface.

The following examples illustrate the invention, but do not impose any limitation.

### EXAMPLES

### Examples 1A, B and C: Preparation of Concentrates

14.6 g of metconazole, 5.0 g of calcium dodecylbenzenesulfonate (CAS No. 26264-06-2; 60% by weight with 40% by weight of 2-ethylhexan-1-ol), 5.0 g of castor oil ethoxylate (40 mol of ethylene oxide per mole) were made up to a volume of 100 ml with a propionamide. Brief stirring at 20° C. gave in each case a clear, colorless solution of metconazole.

The following were employed as propionamide (Example 1A, 1B and 1C, respectively):

A) 3-hexyloxy-N,N-dimethylpropionamide
B) 3-isobutyloxy-N,N-dimethylpropionamide
C) 3-(2-ethylhexyl)oxy-N,N-dimethylpropionamide

The propionamides were obtained by processes known from the literature by subjecting N,N-dimethylacrylamide to an addition reaction with the corresponding alcohol and purifying the product by distillation.

### Example 2

### Solubility of Pesticides

The maximum solubility of various pesticides was determined by adding a pesticide to stirred solvent until the saturation point was reached. As shown in Table 1, the pesticides show very good solubility in the propionamides A, B and C (all data in % by weight at 22° C.). Genagen® 4166 is an N,N-dimethyl fatty acid amide (commercially available from Clariant). Purasolv EHL is 2-ethylhexyl acetate (commercially available from Purac).

TABLE 1

| Solvent | Epoxiconazole | Boscalid | Metrafenone | Metconazole |
|---|---|---|---|---|
| A | 10.0% | 14.8% | 19.8% | 34.5% |
| B | 13.2% | 17.2% | 23.0% | 37.5% |
| C | 7.4% | 9.5% | 14.8% | 30.5% |
| Genagen ® | 7.8% | 5.6% | 18.0% | 37.5% |
| 4166 | | | | |
| Purasolv ® | 6.5% | 0.9% | 5.1% | 21.5% |
| EHL | | | | |

### Example 3

### Physical Data of the Aqueous Spray Mixture

The samples of Example 1A, B and C were diluted to the concentration of a conventional spray mixture with water (CIPAC water D) (in each case 0.51 of concentrate from Example 1 per 200 l of final volume) and analyzed using the following measurement methods. The results are compiled in Table 2.

TABLE 2
Physical data of samples of Example 1A, B and C

| | Static surface | Dynamic surface | |
|---|---|---|---|
| | tension | tension | Spreading |
| Sample | [mN/m] | [mN/m] | [%] |
| A | 31.8 | 46.7 | 359 |
| B | 33.6 | 58.1 | 311 |
| C | 28.9 | 35.7 | 2205 |

Static surface tension: The measurement of the static surface tension gives a characteristic for the surface activity of the formulation in the spray solution. There is a dependence on the concentration of the surface-active formulation components. Above the critical micelle concentration (CMC), the static surface tension remains largely constant. The measurement is effected with an instrument from Krüss (K 12 or K 100) using the Wilhelmy plate method. Here, the lower edge of a vertically hung platinum plate is brought into contact and wetted with the liquid to be measured. The surface tension of the liquid can be calculated in mN/m from the force with which the plate is drawn into the liquid. 40 ml of the spray solutions which have been made up are filled into the instrument, and the surface tension is determined. The static surface tension is determined when five successive readings agree within 0.1 mN/m. The literature provides the following comparative values at 20° C.:

20-25 mN/m extremely low values, typical of silicone surfactants
26-30 mN/m low values, very good surfactant properties
30-35 mN/m good wetting activity
73 mN/m distilled water

Dynamic surface tension (DST): The DST characterizes the diffusion behavior of surface-active formulation components. Here, the change in surface tension is determined as a function of time. It is indirectly also a measure for the adhesion/retention of spray droplets in the plant stand. In the course of drop formation dynamics, relatively low DST values lead to relatively small drops. The latter are capable of spreading more rapidly on the leaf surface and rebound less. The dynamic surface tension is measured with a Krüss bubble tensiometer of the BP 2 type. 40 ml of the spray solutions which have been made up are filled into the instrument, and the dynamic surface tension is determined over 10 s. With this instrument, the earliest determination is possible after 10 msec, and, as a rule, it is this value that is displayed.

Spreading on the leaf surface: To carry out the measurement, 1-μl-drops of the spray mixture are applied to the oilseed rape leaves using a Hamilton syringe. The drop applied is photographed and measured. Then, the drying of the spray drop is monitored visually, and the dried drop is again photographed and measured. The size before and after drying gives the spreading factor in %.

Wetting angle: When a spray drop arrives on a leaf, the drop must form a boundary surface with the adaxial side of the leaf, i.e. the cuticle, and the air. Whether the drop will now wet the leaf or remain as a defined drop on the leaf surface depends on the morphology of the leaf surface and on the “wetting activity” of the spray drop. Measuring the contact angle is a measure for the wetting. The instrument used is the G 10 goniometer from Krüss. Sample C was measured on oilseed rape leaves 10, 30 and 60 s after applying the drop to the leaf surface. The wetting angle was in each case 0°. This means that the drop has immediately optimally spread out smoothly on the leaf surface.

1-13. (canceled)

14. A liquid composition comprising a pesticide in dissolved form, a nonionic surfactant and a propionamide of the formula I 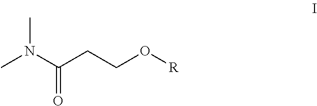
where R is a linear or branched C₃- to C₁₂-alkyl radical.

15. The composition according to claim 14, where R is iso-butyl, n-hexyl, 2-ethylhexyl, 2-propylheptyl, 3,5,5-trimethylhexyl, 7-methyloctyl, 8-methylnonyl or n-decyl.

16. The composition according to claim 14, where R is 2-ethylhexyl.

17. The composition according to claim 14, comprising 5 to 90% by weight of propionamide.

18. The composition according to claim 14, comprising an anionic surfactant.

19. The composition according to claim 18, where the anionic surfactant comprises a sulfonate.

20. The composition according to claim 14, comprising from 0.5 to 60% by weight of pesticide.

21. The composition according to claim 15, where the pesticide has a solubility in water of no more than 20 g/l at 20° C.

22. The composition according to claim 14, comprising at least 15% by weight of the propionamide.

23. The composition according to claim 14, where the pesticide is present in dissolved form.

24. A process for the preparation of the composition according to claim 14 by bringing the pesticide, the nonionic surfactant and the propionamide into contact with each other.

25. An emulsion, comprising water and the composition according to claim 14.

26. A method for controlling phytopathogenic fungi, undesired plant growth, or undesired insect or mite attack, or for regulating the growth of plants comprising allowing the composition of claim 14 to act on the respective pests, their environment or the plants to be protected from the respective pests, the soil, on undesired plants, the useful plants and/or their environment.

27. The method of claim 26, wherein R of the compound of formula I is 2-ethylhexyl.

28. The method of claim 26, wherein the composition comprises 5 to 90% by weight of propionamide.

29. The method of claim 26, wherein the composition comprises an anionic surfactant.

30. The method of claim 29, wherein the anionic surfactant comprises a sulfonate.

31. The composition according to claim 14, comprising from 0.5 to 60% by weight of pesticide.

32. The composition according to claim 15, where the pesticide has a solubility in water of no more than 20 g/l at 20° C.

33. A method for controlling undesired insect or mite attack on plants and/or for controlling phytopathogenic fungi and/or for controlling undesired plant growth, comprising treating seeds of useful plants with the composition of claim 14.
